(19) United States
(12) Patent Application Publication
(10) Pub. No.: US 2008/0248818 A1
(43) Pub. Date: Oct. 9, 2008

(54) Method and Apparatus Providing Multimode Response Options to an Incoming Voice or Text Message

(75) Inventors: Prema Venkatesulu, Yardley, PA (US); Robert H. Folk, Narberth, PA (US); William J. Garrison, Warminster, PA (US); Yucheng Jin, Chalfont, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/697,121

(22) Filed: Apr. 5, 2007

(51) Int. Cl. H04Q 7/20

(52) U.S. Cl. 455/466

(57) ABSTRACT

A method and apparatus is provided for allowing a recipient to reply to an inbound message. The method begins by receiving a message from a sender using a first communication service. The message includes a first contact identifier for the sender. A plurality of user-selectable contact identifiers is presented to the recipient for communicating with the sender using a plurality of different communication services associated therewith. A selected one of the plurality of contact identifiers other than the first contact identifier is selected or otherwise identified by the recipient. A second message is transmitted to the sender using the selected contact identifier and the communication service associated therewith.

### FIELD OF THE INVENTION

The present invention relates generally to communication devices such as wireless telephones and the like, and more particularly to a wireless communication device that allows a user to respond to a message using any desired communication application.

### BACKGROUND OF THE INVENTION

Conventional mobile communication devices, such as cellular telephones and Personal Digital Assistants (PDAs) with communication capability, can be configured to support a variety of communication applications or services, including, for example, a voice communication service, Short-Message-Service (SMS), Enhanced Message Service (EMS), Multimedia Messaging Service (MMS), and Instant Messaging (IM). Each of these services sends and delivers messages of different types. A message may include text and/or multimedia data. For example, a message may include text for a short-message service (SMS) application and a multimedia message may include text and multimedia data such as images and/or sound for a multimedia message service (MMS) application.

A short-message service (SMS) is a supplementary service provided to users of wireless communication terminals. The users exchange a short-message, currently less than about 80 Kbytes, through wireless communication devices without requiring additional equipment. Since the short-message reaches the corresponding user instantly after transmitting the short-message, the SMS has been used for various purposes. Other message services operate in a similar manner.

For each of the different message services the user will typically have a unique contact identifier such as a telephone number, an SMS address or identifier, an IM address or identifier, etc. In general, a contact identifier refers to a number, address (e.g., e-mail address), or other identifier used to establish communication with a contact person using a given communication application or service.

Conventional communication devices often include a personal address book or directory that allows a user or subscriber to store frequently dialed telephone numbers. The user can access the stored telephone numbers in the directory and direct the telecommunication device to dial a particular telephone number. The directory allows the user to place a call to one or more of the stored numbers without physically dialing the entire telephone number. The directory may also be used to store additional contact identifiers such as an SMS identifier and an IM address, for example. Accordingly, conventional address books can become filled with enough information that they are difficult to navigate and use.

When a user receives an inbound message on the communication device the name and/or the contact identifier of the caller may be stored in a recently called list that is maintained in the communication device. One easy way for the user to respond to the message is by calling the caller back or sending a text message, often by selecting a reply or send button or icon while viewing the call list. The message generally will be returned using the same communication service over which it was received and stored in the call list. For example, if the caller left a voice message, selecting the reply button will initiate a return phone call to the caller at the caller's telephone number. Likewise, if the caller left an IM message, selecting the reply button will initiate a return IM message using the caller's IM address. If the user wants to return a message by a different communication service the user first needs to launch the desired communication service and access the address book to obtain the callers contact identifier for that particular service. Not only does this require a number of steps that may be cumbersome, but it also requires the user to navigate through the address book, which as previously noted can itself be a cumbersome task.

### SUMMARY OF THE INVENTION

In accordance with the present invention, a method and apparatus is provided for allowing a recipient to reply to an inbound message. The method begins by receiving a message from a sender using a first communication service. The message includes a first contact identifier for the sender. A plurality of user-selectable contact identifiers is presented to the recipient for communicating with the sender using a plurality of different communication services associated therewith. A selected one of the plurality of contact identifiers other than the first contact identifier is selected or otherwise identified by the recipient. A second message is transmitted to the sender using the selected contact identifier and the communication service associated therewith.

In accordance with one aspect of the invention, the first communication service is a telephony communication service and the first contact identifier is a telephone number.

In accordance with another aspect of the invention, one of the plurality of different communication services includes an e-mail service and the contact identifier is an e-mail address.

In accordance with another aspect of the invention, one of the plurality of different communication services includes a Short Message Service and the contact identifier is an Short Message Service identifier.

In accordance with another aspect of the invention, one of the plurality of different communication services includes an IP telephony service and the contact identifier is a telephone number.

In accordance with another aspect of the invention, a communication device such as a cellular telephone is provided. The communication device includes a computer-readable storage medium configured to store a database having a plurality of contact entries each of which includes one or more contact identifiers. The device also includes a processor responsive to the computer-readable storage medium and to a software program. The software program, when loaded into the processor, is operative to: map a contact identifier associated with an incoming message to a contact entry stored in the database; access the contact entry; present to a user a plurality of contact identifiers associated with the accessed contact entry from among which the user may select; and launch a communication application associated with a selected one of the contact identifiers.

In accordance with another aspect of the invention, the software program is further operative to establish communication over a communication network using the selected contact identifier.

### BRIEF DESCRIPTION OF THE DRAWINGS

FIG. 1 shows a contact entry that is a part of an address book or directory that can be accessed by a user of a communication device such as a mobile telephone.

FIG. 2 is a flowchart illustrating one example of a method that may be used to reply to a caller's message using the multimode response program that resides on the communication device.

FIG. 3 is a block diagram illustrating one example of communication device employing the methods and techniques described herein for responding to an incoming message.

### DETAILED DESCRIPTION

To overcome the aforementioned problems and limitations, a communication device is provided with a multimode response program to allow a user to simply and conveniently return a caller's incoming message using any desired communication service and not simply the communication service over which the incoming message was received.

The communication devices referred to herein can include a variety of forms, such as, for example, conventional telephones, mobile telephones, paging units, radio units, wireless data devices, iP telephones, portable or wireless telephones, personal information managers (PIMs), personal digital assistants (PDAs), personal computers (PCs), network televisions (TVs), Internet TVs, Internet telephones, portable wireless devices, workstations or any other suitable communication device.

Regardless of its specific form, the communication device has a user-input interface and a user-output interface. The user-input interface receives input from the subscriber. The user-output interface provides output to the subscriber. Examples of the user-input interface include, but are not limited to, an electroacoustic transducer such as a microphone to receive voice and other audible input from the subscriber, a keypad or a keyboard to receive key strokes from the subscriber, a touchpad or touchscreen to receive touch input from the subscriber, and a pointing device such as a mouse or a trackball to receive point and click inputs from the subscriber. Examples of the user-output interface include, but are not limited to, an electroacoustic transducer such as a speaker to provide voice and other audible output to the subscriber, and a visual display device such as a liquid crystal display or a cathode ray tube to provide graphical and/or textual information to the subscriber. It is noted that the communication device may include more than one user-input interface and more than one user-output interface. For example, a wireless telephone may have a microphone, a telephone keypad, a speaker, and a visual display device. The communication device may include one or more applications that facilitate communication between the communication device and other individuals. These communications applications may take the form of a software program, a piece of code, a device, a hardware component, a processor, or a combination thereof, which independently or collectively direct operations of the communication device. For instance, such communication applications may include e-mail programs, instant message programs, file transfer protocol (FTP) programs, and voice over internet protocol (VoIP) programs. As previously noted, an additional application associated with the communication device is a multimode response program or application.

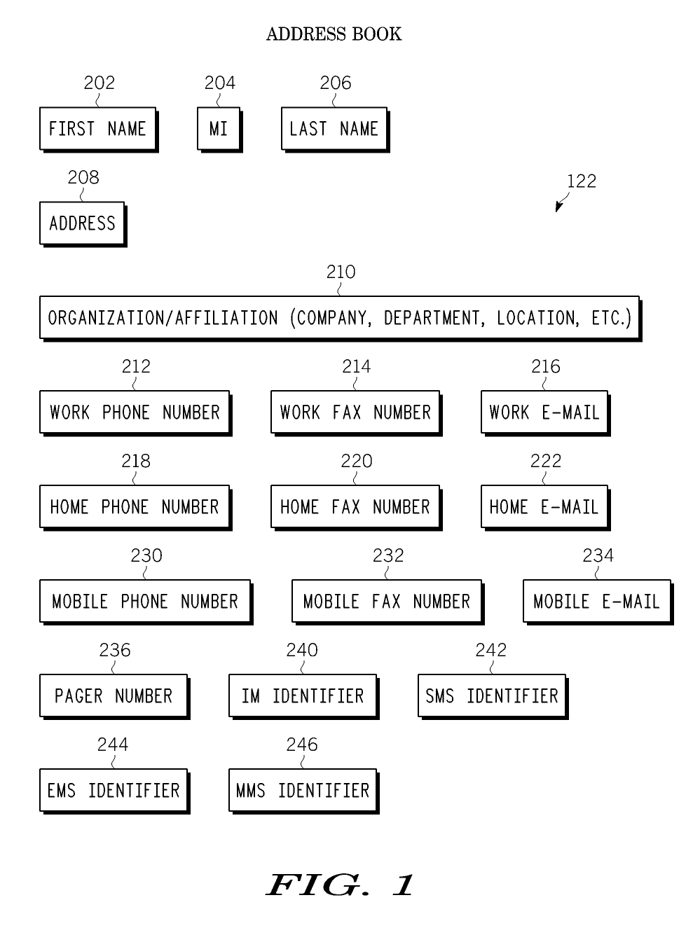

FIG. 1 shows a contact entry 122 that is a part of an address book or directory that can be accessed by a user of a communication device. The address book may be presented to the subscriber via one of the user-output devices such as the display. The address book will generally include multiple such contact entries, one for each individual for whom the user wishes to maintain contact information. The contact entry, in this particular example, includes the contact's name 202, 204, 206, address 208, and organization/affiliation 210. The contract entry 122 also includes a number of different contact identifiers including, by way of example, a work telephone number 212, work fax number 214, work e-mail 216, home telephone number 218, home fax number 220, home e-mail 222, mobile phone number 230, mobile fax number 232, mobile e-mail 234, pager number 236, IM identifier 240, SMS identifier, EMS identifier 244 and MMS identifier 246. In general, the contact entry 122 may include additional, fewer and/or different entries from those depicted in FIG. 1.

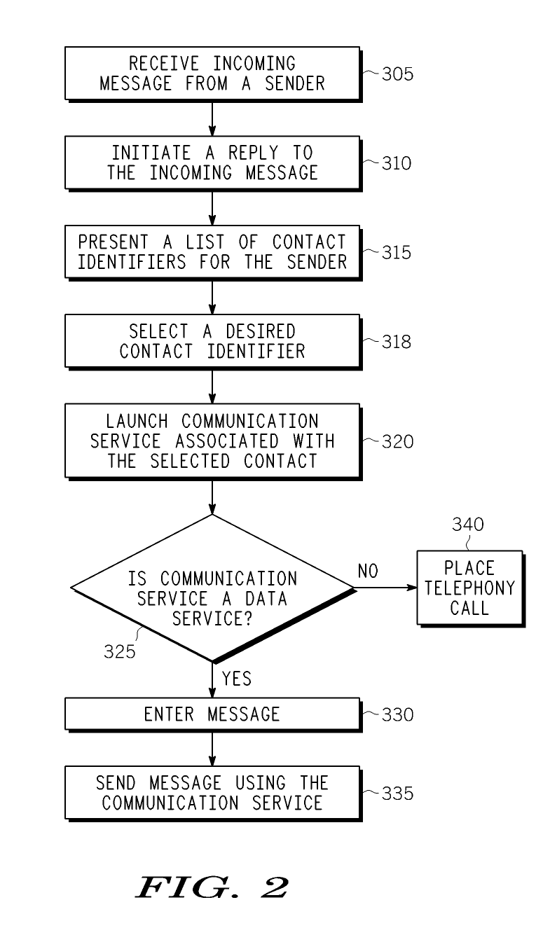

FIG. 2 is a flowchart illustrating one example of a method that may be used to reply to a caller's message using the multimode response program that resides on the communication device. First, in step 305 the communication device receives a message from a sender using any available communication service such as a telephony communication service, a short message service, an e-mail service or the like. The message will generally include the contact identifier for the sender which is associated with that service. The message will typically be a voice message, text message or multimedia message. Next, in step 310, the user decides to reply to the message. In the case of a text or multimedia message, the user may initiate a reply while viewing the message by selecting the appropriate button or icon on the communication device. In the case of a voice message, the user may initiate a reply by scrolling through a list of recently received calls. Once the user executes a command to reply to the message, the multimode response program accesses and presents to the user in step 315 a list of any available contact identifiers for the caller. The contact identifiers may be accessed by locating the contact entry for the caller from an address book, such as the directory shown in FIG. 1, for example. After the user selects one of the contact identifiers 318, the communication device launches the corresponding communication application or service in step 320.

If the communication application selected in step 318 is determined to be a data application at decision step 325, such as an SMS application, then the user can enter the data, or message, to be transmitted in step 330. Then the data can be sent in step 335 using the selected contact identifier, e.g., the SMS identifier. On the other hand, if the application is a voice application, for example, then a telephony connection can be made, e.g., a call can be placed, using the selected contact identifier in step 340.

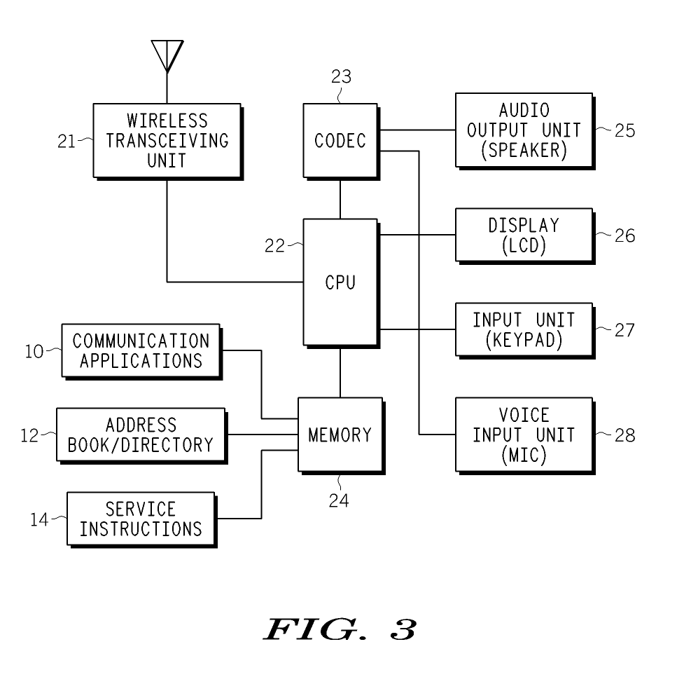

FIG. 3 is a block diagram illustrating one example of communication device employing the methods and techniques described herein for responding to an incoming message. For purposes of illustration only the communication device is illustrated as a wireless communication device such as a cellular telephone. The wireless communication device includes a wireless transceiving unit 21, a central processing unit (CPU) 22, a CODEC 23, a memory 24, an audio output unit such as a speaker 25, a display unit such as liquid crystal display (LCD) 26, an input unit such as a keypad 27 and a voice input unit such as a microphone 28. The wireless transceiving unit 21 transmits and receives signals through a wireless communication link using an antenna that can comprise a single or antenna or multiple antennas, e.g., for spatial diversity, or even one or more arrays of antennas.

The central processing unit (CPU) 22 generally drives and controls the wireless communication device. CPU 22 can comprise multiple processors or processing circuits, such as Digital signal Processors (DSPs), audio processors, math coprocessors, etc. These processors and/or processing circuits can be included in a single Integrated Circuit (IC), or several ICs, and can be packaged in a single chip package or multiple chip packages.

The CODEC 23 converts a signal transferred from the wireless transceiving unit 21 to voice in response to a control of the CPU 22 and outputs the voice to the audio output unit 25. The CODEC 23 also converts voices input from the audio input unit 28 to a signal and transfers the signal to the CPU 22. The signal is transmitted through the wireless transceiving unit 21. The audio output unit 25 outputs the voice transferred from the CODEC 23 and the audio input unit 28 receives the voice and transfers the voice to the CODEC 23. The display unit 26 outputs various screens for displaying a caller's telephone number or a short-message editing screen in response to the CPU 22. The input unit 27 receives a menu selection signal including a short-message transmitting request signal, a receiver's telephone number and a short-message using a plurality of buttons prepared on the input unit 27.

The communication device also includes a memory 24 coupled with processor 22, which can be configured to store instructions 14 and data that can be used by processor 22 to control the operation of device. In addition, memory 24 can be configured to store an address book 12, which can comprise contact information as described above. Memory 24 can also store applications such as communication applications 10, which can include, e.g., a SMS application, MMS application, EMS application, IM application, voice-over-IP application, and the like. Memory 24 can also store the multimode response program that is used to launch the appropriate communication application when a contact identifier is selected by the user. It should be noted that memory 24 can be one or multiple device contained in one or more multiple circuit packages. For example, memory 244 can include static or dynamic memory, erasable memory, removable memory, etc.

Thus, a user can initiate a reply to an incoming message received from a sender (step 310) via the input unit 27. The multimode response program residing in memory 24 presents the list of contact identifiers for the sender (step 315) on the display 26 by mapping the contact identifier received along with the message to the contact entry for the sender located in address book 12. The user causes ones of the communication applications 10 to be launched (step 320) by selecting a desired contact identifier (step 318) via commands entered through input unit 27 or voice input unit 28. Once launched, the user can enter a message with the input unit 27 or, alternatively, the user can place a voice call with the voice input unit 28. The selected communication application can then send the message, or initiate communication, using the selected contact identifier (step 335).

The multimode response program can comprise part of the various communication applications 10 or it can be an overlay that works in conjunction with each of the communication applications 10. Moreover, it should be noted that multimode response program need not reside exclusively or even partially in software. More generally, the multimode response program may reside in any combination of software, firmware and hardware.

Although a specific architecture has been described in FIG. 3, including specific functional elements and relationships, it is contemplated that the systems and methods described herein may be implemented in a variety of ways. For example, functional elements may be packaged together or individually, or may be implemented by fewer, more or different devices, and may be either integrated within other products, or adapted to work with other products externally. When one element is indicated as being responsive to another element, the elements may be directly or indirectly coupled.

The process shown in FIG. 2 may be implemented in a general, multi-purpose or single purpose processor. Such a processor will execute instructions, either at the assembly, compiled or machine-level, to perform that process. Those instructions can be written by one of ordinary skill in the art following the description of FIG. 2 and stored or transmitted on a computer readable medium. The instructions may also be created using source code or any other known computer-aided design tool. A computer readable medium may be any medium capable of carrying those instructions and includes, without limitation, a CD-ROM, DVD, magnetic or other optical disc, tape, silicon memory (e.g., removable, non-removable, volatile or non-volatile), as well as packetized or non-packetized wireline or wireless transmission signals.

It will furthermore be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

1. At least one computer-readable medium encoded with instructions which, when executed by a processor, performs a method including:
receiving a message from a sender using a first communication service, said message including a first contact identifier for the sender;
presenting a plurality of user-selectable contact identifiers for communicating with the sender using a plurality of different communication services associated therewith;
identifying a selected one of the plurality of contact identifiers other than the first contact identifier; and
sending a second message to the sender using the selected contact identifier and the communication service associated therewith.

2. The computer readable medium of claim 1 wherein the first communication service is a telephony communication service and the first contact identifier is a telephone number.

3. The computer readable medium of claim 1 wherein one of the plurality of different communication services includes an e-mail service and the contact identifier is an e-mail address.

4. The computer readable medium of claim 1 wherein one of the plurality of different communication services includes a Short Message Service and the contact identifier is an Short Message Service identifier.

5. The computer readable medium of claim 1 wherein one of the plurality of different communication services includes an IP telephony service and the contact identifier is a telephone number.

6. At least one computer-readable medium encoded with instructions which, when executed by a processor, performs a method including:
identifying a sender associated with an incoming message;
accessing a database that includes a plurality of contact entries each of which includes one or more contact identifiers to locate a contact entry associated with the sender;
prompting a user to select one of the contact identifiers associated with the sender; and
launching a communication application associated with the selected contact identifier.

7. The computer readable medium of claim 6 wherein the communication application is selected from the group consisting of a voice communication application, a Short-Message-Service (SMS) application, an Enhanced Message Service (EMS) application, a Multimedia Messaging Service (MMS) application, an Instant Messaging (IM) application, an IP-telephony application and an e-mail application

8. The computer readable medium of claim 6 wherein the database is accessed in response to a user request to reply to the incoming message.

9. The computer readable medium of claim 6 wherein the contact identifiers are selected from the group consisting of a telephone number, a Short-Message-Service (SMS) identifier, an Enhanced Message Service (EMS) identifier, a Multimedia Messaging Service (MMS) identifier, an Instant Messaging (IM) identifier and an e-mail address.

10. The computer readable medium of claim 6 further comprising sending a message to the selected contact identifier using the communication application that is launched.

11. A communication device, comprising:
a computer-readable storage medium configured to store a database having a plurality of contact entries each of which includes one or more contact identifiers;
a processor responsive to the computer-readable storage medium and to a software program, the software program, when loaded into the processor, operative to:
map a contact identifier associated with an incoming message to a contact entry stored in the database;
access the contact entry;
present to a user a plurality of contact identifiers associated with the accessed contact entry from among which the user may select; and
launch a communication application associated with a selected one of the contact identifiers.

12. The device of claim 11 wherein the software program is further operative to establish communication over a communication network using the selected contact identifier.

13. The device of claim 12 wherein the communication network is a wireless network.

14. The device of claim 12 wherein the communication network is a cellular network.

15. The device of claim 11 wherein the communication application is selected from the group consisting of a voice communication application, a Short-Message-Service (SMS) application, an Enhanced Message Service (EMS) application, a Multimedia Messaging Service (MMS) application, an Instant Messaging (IM) application, an IP-telephony application and an e-mail application

16. The device of claim 11 wherein the database is accessed in response to a user request to reply to the incoming message.

17. The device of claim 11 wherein the contact identifiers are selected from the group consisting of a telephone number, a Short-Message-Service (SMS) identifier, an Enhanced Message Service (EMS) identifier, a Multimedia Messaging Service (MMS) identifier, an Instant Messaging (IM) identifier and an e-mail address.

18. The device of claim 11 further comprising sending a message to the selected contact identifier using the communication application that is launched.
